(19) United States
(12) Patent Application Publication
(10) Pub. No.: US 2026/0072321 A1
(43) Pub. Date: Mar. 12, 2026

(54) DIMMING-INDEPENDENT ANTENNA SYSTEM FOR WEARABLE OPTICAL DEVICES

(71) Applicant: Meta Platforms Technologies, LLC, Menlo Park, CA (US)

(72) Inventors: Yasuo MORIMOTO, Cupertino, CA (US); Wei HUANG, San Diego, CA (US); Diaaaldin J.M. BISHARAT, Palo Alto, CA (US); Boon SHIU, Palo Alto, CA (US); Jiang ZHU, Cupertino, CA (US); Geng YE, San Jose, CA (US)

(73) Assignee: Meta Platforms Technologies, LLC, Menlo Park, CA (US)

(21) Appl. No.: 19/303,902

(22) Filed: Aug. 19, 2025

Related U.S. Application Data
(60) Provisional application No. 63/692,296, filed on Sep. 9, 2024.

(51) Int. Cl. G02F 1/163; G02F 1/153; H01Q 1/27; H01Q 1/38

(52) U.S. Cl. CPC G02F 1/163; H01Q 1/273; H01Q 1/38; G02F 2001/1536

(57) ABSTRACT

Systems and methods for providing a dimming-independent antenna-on-lens solution for wearable optical devices are disclosed. A system can include a support structure, at least one lens mounted to the support structure, and a transparent antenna film layer disposed on at least a portion of the lens, where the transparent antenna film layer includes at least one antenna. The system further includes an active dimming structure comprising a transparent conductive layer that is electrically coupled with a short structure configured to conduct current induced by the antenna away from the transparent conductive layer of the active dimming structure. The disclosed configuration enables reliable antenna performance regardless of dimming technology by mitigating RF losses associated with lossy conductive layers, supporting consistent wireless operation in devices such as augmented reality or virtual reality eyewear.

### CROSS-REFERENCE TO RELATED APPLICATION

This application claims priority to U.S. Provisional Patent Application No. 63/692,296, filed Sep. 9, 2024, which is incorporated by reference in its entirety for all purposes.

### FIELD OF DISCLOSURE

The present disclosure is generally related for wireless communication antennas, including, but not limited to antenna designs for wireless communications in wearable devices.

### BACKGROUND

Wearable optical devices, such as augmented reality and virtual reality headsets, are increasingly used to provide enhanced visual experiences and interactive functionalities. These devices often incorporate various optical and electronic components, including lenses, sensors, and wireless communication systems, within compact form factors. However, integrating multiple functionalities into wearable optical devices while maintaining reliable wireless performance and user comfort can be challenging.

### SUMMARY

Integration of antennas in wearable optical devices can be a challenge as such systems may encounter significant performance degradation when transparent conductive materials are used for optical dimming. Active dimming layers can use transparent conductive oxides, such as indium tin oxide, which can introduce lossy paths for radio frequency signals and can impair antenna efficiency. Sometimes, passive dimming layers can utilize organic molecules embedded within the lens substrate, which can avoid lossy conductive materials but can rely on different antenna architectures. Accommodating both active and passive dimming technologies can involve distinct antenna-to-radio frequency front end configurations, which can increase production complexity and limit the ability to maintain consistent wireless performance across product variants. Attempts to place antennas on the lens surface can be constrained by the presence of lossy conductive layers, which can couple to antenna structures and can result in reduced signal strength or increased interference.

The techniques described herein can address antenna performance challenges in wearable optical devices by providing an antenna-on-lens system that can reduce lossy currents and operate independently of dimming conditions. The technical solutions can involve antenna-on-lens systems with a transparent antenna film layer disposed on at least a portion of a lens, where the transparent antenna film layer can include a transparent meshed metal and can be electrically coupled to a short structure, such as a radio frequency short structure. The short structure can be electrically connected to a transparent conductive layer used for active dimming, such that lossy radio frequency currents can be cancelled or diverted from the transparent conductive layer of the dimming structure.

At least one aspect relates to a system. The system can include a support structure. The system can include at least one lens mounted to the support structure. The system can include a transparent antenna film layer that is disposed on at least a portion of the lens, where the transparent antenna film layer includes at least one antenna. The system can include an active dimming structure comprising a transparent conductive layer that is electrically coupled with a short structure, such as a radio frequency (RF) short structure, that can be configured to conduct current induced by the antenna away from the transparent conductive layer of the active dimming structure.

The RF short structure can include a reactive component configured as a portion of a high pass filter. The reactive component can include at least one of a capacitor or an inductor. The high pass filter can include a cut-off frequency of at least 100 kilohertz. The system further comprises a second RF short structure that is electrically coupled with the antenna, where the second RF short structure can include a second reactive component comprising at least one of a capacitor or an inductor. The second reactive component can be configured to reduce coupling between the antenna and the transparent conductive layer.

The second reactive component can be configured as a portion of a band pass filter. The band pass filter can allow for passing of signals with a frequency range of at least between 2.4 GHz and 7 GHz. Each of the RF short structure and the second RF short structure can be coupled to a common ground coupled with at least a portion of the support structure. The transparent antenna film layer can comprise at least one of: an indium tin oxide (ITO), a silver nanowire, or a graphene.

The active dimming structure can be configured as an electrochromic device operable to adjust optical transmission in response to an applied electrical signal. The RF short structure can be integrated into a circuit that conforms to one of a curvature of the lens of an eyewear device, or a curvature of a bridge of the eyewear device. The support structure can include a frame configured for eyewear, a visor, or a heads-up display device. The transparent conductive layer can include a mesh pattern configured to facilitate visible light transmission while maintaining electrical conductivity.

At least one other aspect relates to a system. The system can include a support structure. The system can include at least one lens mounted to the support structure. The system can include a transparent antenna film layer that is disposed on at least a portion of the lens, where the transparent antenna film layer includes at least one antenna. The system can include a radio frequency (RF) short structure that is electrically connected to the transparent antenna film layer.

The transparent antenna film layer can comprise a transparent meshed metal. The transparent antenna film layer can be disposed over a transparent conductive layer of the lens. The transparent conductive layer of the lens can include an active dimming structure including one or more indium tin oxide (ITO) layers. The RF short structure can be electrically connected to the transparent conductive layer. The RF short structure can be configured to prevent electrical interference between an antenna feeding structure and a dimming bias.

At least one other aspect relates to a method. The method can be a method to provide a lens structure with an active dimming. The method can include providing a support structure. The method can include mounting at least one lens to the support structure. The method can include disposing a transparent antenna film layer on at least a portion of the lens, the transparent antenna film layer including at least one antenna. The method can include providing an active dimming structure comprising a transparent conductive layer. The method can include electrically coupling the transparent conductive layer with a radio frequency (RF) short structure to conduct current induced by the antenna away from the transparent conductive layer via the RF short structure.

The RF short structure can include a reactive component configured as a portion of a high pass filter. The reactive component can include at least one of a capacitor or an inductor. The high pass filter can include a cut-off frequency of at least 100 kilohertz.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular form of ‘a,’ ‘an,’ and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1A is a front view of an example of augmented-reality glasses for active dimming, in accordance with one or more implementations;

FIG. 1B is a front view of an example of augmented-reality glasses for passive dimming, in accordance with one or more implementations;

FIG. 2A is a cross-sectional view of a lens structure with an integrated transparent antenna and a short structure, in accordance with one or more implementations;

FIG. 2B is a cross-sectional view of a lens structure with a short structure and active dimming stack for augmented reality glasses, in accordance with one or more implementations;

FIG. 2C is a cross-sectional view of a lens structure with a short structure for active dimming applications, in accordance with one or more implementations;

FIG. 2D is a cross-sectional view illustrating a lens structure with a short structure in a passive dimming configuration, in accordance with one or more implementations;

FIGS. 3A and 3B are illustrations of example graphs detailing scattering parameters and antenna efficiencies for active dimming and passive dimming.

FIG. 4 is an illustration of example augmented-reality glasses that may be used in connection with embodiments of this disclosure.

FIG. 5 is an illustration of an example virtual-reality headset that may be used in connection with embodiments of this disclosure; and

FIG. 6 is a flow chart illustrating a method for providing a lens structure configured for dissipating current from a dimming structure, in accordance with one or more implementations.

### DETAILED DESCRIPTION

Below are detailed descriptions of various concepts related to, and approaches, methods, apparatuses, and systems for implementing the various techniques described herein. The various concepts introduced above and discussed in greater detail below may be implemented in any of numerous ways, as the described concepts are not limited to any particular manner of implementation. Examples of specific implementations and applications are provided primarily for illustrative purposes.

Wearable optical devices can include augmented reality glasses, virtual reality headsets, and other head-mounted displays. Such devices can integrate a variety of optical and electronic components to support visual augmentation, wireless communication, and interactive functionality. Transparent conductive materials, such as indium tin oxide and transparent metal mesh, can be used in the construction of lenses to support features such as optical dimming and antenna integration. Dimming technologies can include active dimming, such as guest-host liquid crystal dimming and electrochromic dimming, as well as passive dimming, such as photochromatic dimming. The integration of antennas directly onto the lens area can provide additional surface area for wireless functionality and can support a range of wireless protocols, including cellular, Wi-Fi, Bluetooth, and global positioning system connectivity.

Different approaches to antenna integration in wearable optical devices can encounter significant technical challenges when transparent conductive layers are used for dimming applications. Transparent conductive oxides, such as indium tin oxide, can introduce lossy paths for radio frequency signals. Such lossy conductive layers can impair antenna efficiency by allowing radio frequency currents to dissipate within the dimming structure. In passive dimming implementations, the absence of conductive layers can require different antenna architectures, which can increase production complexity and limit the ability to maintain consistent wireless performance across product variants. Attempts to address these challenges by modifying antenna placement or using alternative materials can result in inconsistent wireless performance or increased manufacturing cost.

The techniques described herein can provide an antenna-on-lens system that can operate independently of the dimming technology used in the lens structure. The techniques described herein can include a transparent antenna film layer disposed on at least a portion of the lens. The transparent antenna film layer can include a transparent meshed metal and can be electrically coupled to a radio frequency short structure. The radio frequency short structure can be electrically connected to a transparent conductive layer used for active dimming, such that lossy radio frequency currents can be cancelled or diverted from the transparent conductive layer. The same antenna-to-radio frequency front end architecture can be used for both active and passive dimming configurations, such that consistent wireless performance can be maintained across different product variants.

Today's mobile electronic devices implement many different types of antennas. To keep up with the evolution of wireless technology and the increasing demands of ubiquitous wireless access, wearable electronic devices may seek to support more and more wireless standards including 3G/4G/5G, Wi-Fi, global positioning system (GPS), Bluetooth, ultrawideband (UWB), and more. To enable multi-standard wireless connectivity, these wearable devices (e.g., smartwatches or augmented reality (AR) glasses) may use several multi-band antennas within a small form factor.

Wearable electronic devices such as AR glasses may implement antennas in the temple arms or in the rims of the glasses. These antennas, however, are constrained in size due to the small form factor of the glasses and may be further constrained in where they can be placed. Moreover, the design of the device, the overall weight, or other factors may lead to continually smaller form factors with reduced size and thickness. Such form factors may have even less room for different types of antennas. In such cases, antennas may need to be further reduced in size which, in turn, decreases the antennas' performance. Still further, in small form factor devices, other electrical and mechanical components may interfere with the operation of the various antennas.

Some implementations may attempt to place antennas on the lenses of AR glasses. Indeed, the lenses may be the single largest component by area on a pair of AR glasses. Placing antennas on the lens glass may provide additional volume for the antennas. Moreover, the lens may have an additional amount of separation or clearance from the user's body (e.g., from their eyes or head). This may reduce the body's effects on antenna signal degradation. In cases where antennas are implemented on AR glass lenses, the antennas may use transparent conductive material that acts as the radiating elements for the antenna. Because the material is transparent, the material does not block the user's vision through the lenses.

That said, however it may be difficult to design a transparent antenna architecture that supports different dimming conditions for AR glasses. For instance, dimming technologies such as photochromatic dimming may not contain a lossy layer that is needed for effective transmitting and receiving of radio frequency signals. Therefore, adjustments to the antenna to radio frequency (RF) front end architecture may need to be made to support the various dimming conditions. However, the same antenna to RF front end architecture may be highly desired for different dimming conditions to reduce production complexity and cost.

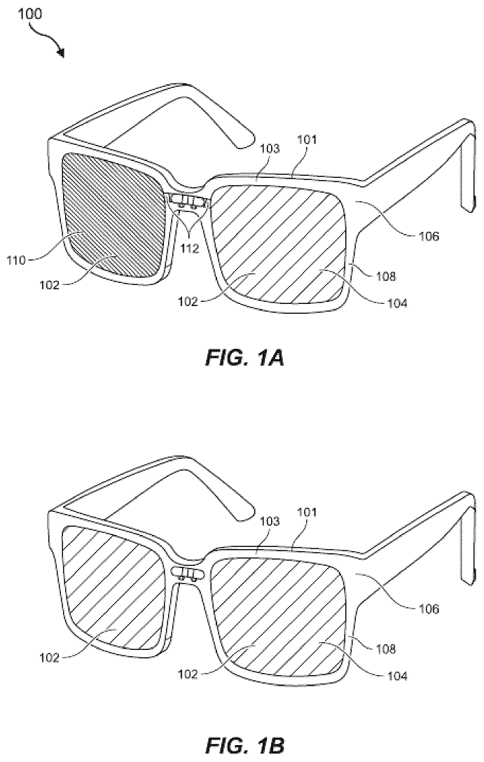

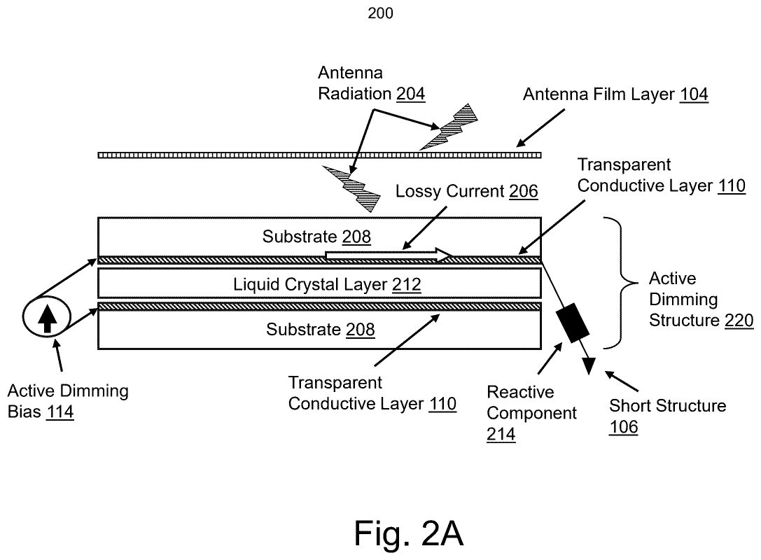

The present disclosure is generally directed to an antenna architecture on a lens system that may support a transparent conductive layer independent of dimming conditions for AR/VR glasses. More specifically, indium tin oxide (ITO) layers may be the transparent conductive layer controlling the light transmission properties that is tightly coupled to a transparent metal mesh cover for active dimming. Any other suitable material may also be used for this layer. An RF short structure may truncate the current between an antenna feeding structure and the other mechanical parts, (e.g. Printed Circuit Board, superflex) allowing a dimmer bias, used for active dimming, to be placed anywhere on the lens system. The RF short structure may be electrically connected to the transparent metal mesh layer or the transparent conductive layer for active dimming or electrically connected to the transparent metal mesh layer for passive dimming. In this manner, the RF short structure may enable the same antenna architecture for different dimming conditions such as passive and active dimming, reducing complexity and cost during the production of AR/VR glasses. Furthermore, the antenna structure on a lens system may free up space for wireless features such as cellular, GPS, Wi-Fi-6E, and Bluetooth. These embodiments will be further described below with regards to FIGS. 1-3.

Features from any of the embodiments described herein may be used in combination with one another in accordance with the general principles described herein. These and other embodiments, features, and advantages will be more fully understood upon reading the following detailed description in conjunction with the accompanying drawings and claims. The following will provide, with reference to FIGS. 1A and 1B, detailed descriptions of AR glasses for active and passive dimming.

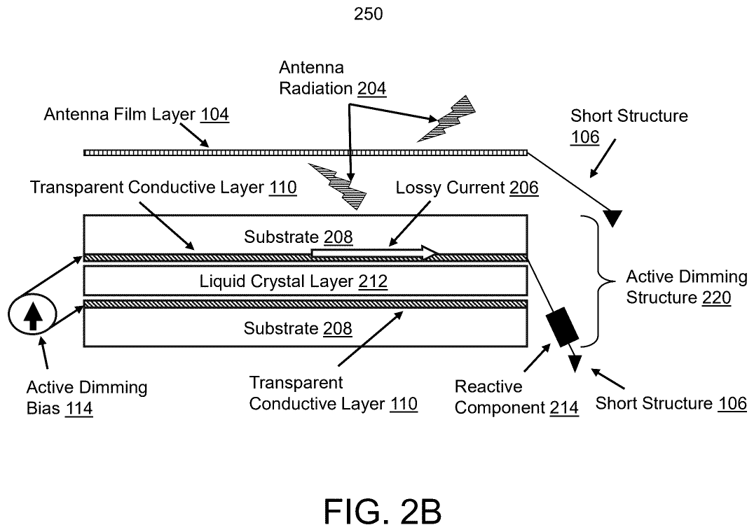

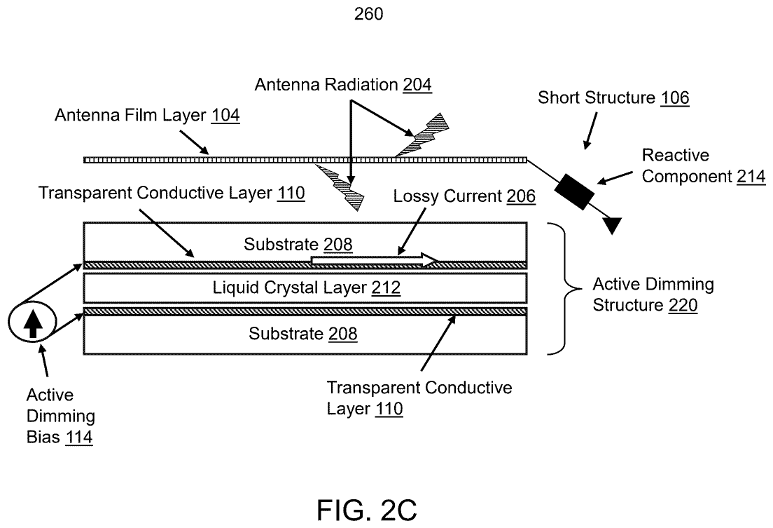

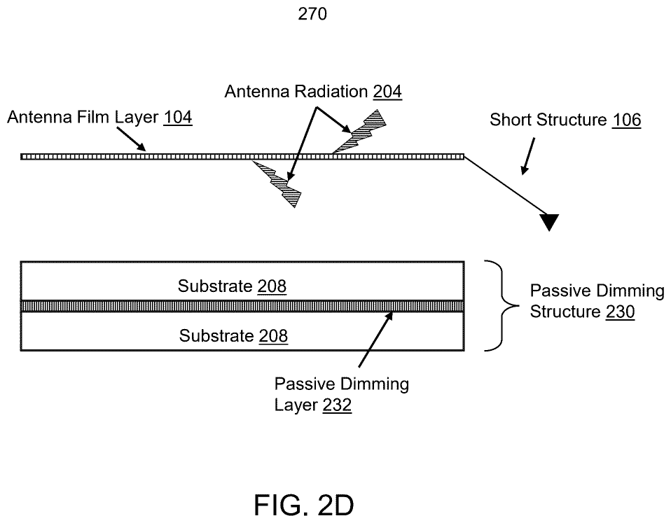

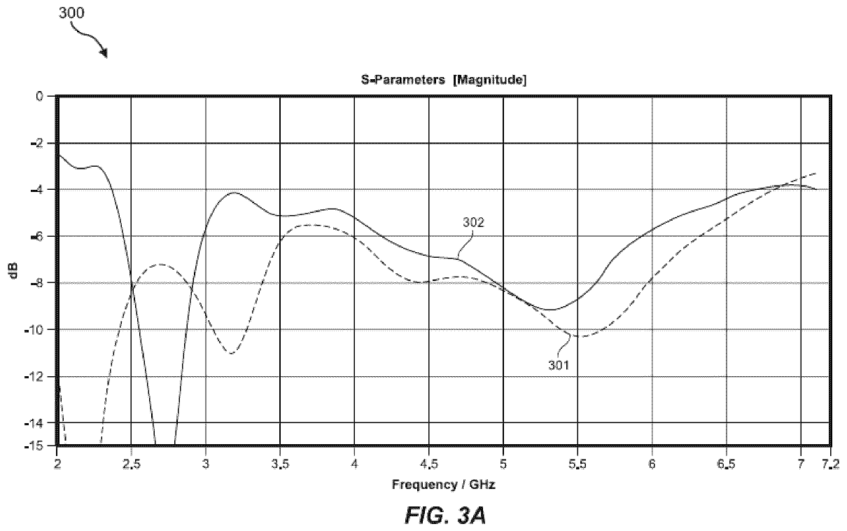

FIGS. 1A and 1B are an illustration of a front view of AR glasses 100 for active dimming and a front view of AR glasses 100 for passive dimming. Referring to FIGS. 1A and 1B, AR glasses 100 may include a frame 101 and two lenses 102 in which one or more of lenses 102 include an antenna 103 placed nearby. In some embodiments, frame 101 may provide a support structure to mount at least one or more lenses 102 and potentially other electronic and/or mechanical components. The frame 101 can serve as a support structure for lens structures with active or passive dimming, such as lens structures 200, 250, 260 or 270 described further in FIGS. 2A-2D. Furthermore, lenses 102 may include a transparent conductive layer 110 for active dimming of AR glasses 100. As used herein, “transparent conductive layer” or transparent conductor, may refer to a coating of a transparent conductive oxide (TCO) such as indium tin oxide (ITO) or some other type of TCO. TCO materials may be somewhat conductive yet still have an appropriate resistivity for good antenna signal. Hence, ITO may be the appropriate material to use for active dimming.

Referring to FIG. 1B, lenses 102 may include a transparent antenna film layer 104 made of some transparent metal or transparent conductive film for passive dimming. As used herein, “transparent antenna film layer” may refer to an optically transparent metal mesh that is ultra-thin and transparent to the human eye. In some embodiments, transparent conductive films may include indium tin oxide or other TCOs, conductive polymers, carbon nanotubes, metallic grids, graphene, nanowire meshes, ultra-thin metal films, or other similar materials or combination thereof.

As shown in FIG. 1B, the transparent antenna film layer 104 may include an antenna 103. In this manner, the transparent antenna film layer 104 may be disposed on at least a portion of lens 102 as part of the antenna radiator. The antenna film layer 104 can include a transparent meshed metal that can be disposed over a transparent conductive layer 110 of the lens. The antenna film layer 104 and the transparent meshed metal can be electrically insulated from each other by a layer of intervening transparent electrical insulator (e.g., glass or another material). In some embodiments, transparent antenna film layer 104 is disposed over transparent conductive layer 110 in at least one of the lenses 102. In further embodiments, the transparent conductive layer 110 used for active dimming, as shown in FIG. 1A, may be tightly coupled to the transparent antenna film layer 104. Transparent antenna film layer 104 may be fed capacitively through a flex along the frame 101 or directly at the opposite side of the nose pads of the AR glasses 100.

Active dimming can refer to a process in which the optical transmission of glasses is modulated using an applied electrical signal. For instance, active dimming may involve a guest-host liquid crystal (GHLC) dimming or electrochromic dimming. For example, active dimming by GHLC dimming may align liquid crystal molecules by applying an electric field to the liquid cell to alter the polarization of light passing through the cell, thereby controlling the brightness and/or opacity. Conversely, passive dimming may refer to photochromatic dimming in which lenses (e.g., lenses 102) automatically adjust the tint in response to different light conditions. In this manner, the transparent conductive layer 110 may not be needed as organic molecules are embedded within the lens material to react to different light conditions. However, to accommodate for the different lighting conditions brought on by both active and passive dimming, an antenna architecture on a lens system may need to be modified to maintain consistent signal to antenna 103.

A short structure 106, such as an RF short structure, may be used for antenna 103 configuration between an antenna feeding structure 108 and other mechanical parts such as PCBs (now shown in drawings), for both passive and active dimming conditions, as shown in FIGS. 1A and 1B. As used herein, “a short structure” may refer to a structure that creates a shorter electrical path for RF signals to improve signal strength for transmitting and receiving data. An RF short structure may be a short structure 106 comprising one or more reactive components (e.g., capacitors or inductors), such as to form a high pass, low pass, band pass or band stop filtering operation. As used herein, “dimmer bias” may refer to a control mechanism for active dimming to adjust transparency electronically for visual comfort and clarity. As RF short structure 106 may prevent electrical interference between an antenna feeding structure 108 and dimmer bias 112, the dimmer bias 112 may be located at any location outside of the antenna feeding structure 108, RF short structure 106, and the transparent antenna film layer 104. The RF short structure 106 may be realized as part of the dimmer bias 112 circuit.

In some embodiments, FIGS. 1A and 1B may include current paths for AR glasses 100. In further embodiments, while the current may be more concentrated throughout the frame and flex area for passive dimming, the current path remains the same for both passive and active dimming because of the RF short structure 106. In this manner, antenna performance in both passive dimming and active dimming may be similar.

FIG. 2A illustrates a cross-sectional schematic view of a lens structure 200 with an integrated transparent antenna and an RF short structure configured to remove currents induced in the transparent conductive layer of the active dimming structure by the antenna. The lens structure 200 can include at least one antenna film layer 104 comprising an antenna circuit that emits or radiates antenna radiation 204. The lens structure 200 can also include an active dimming structure 200 that can be electrically coupled to an active dimming bias 114 for biasing or operating the active dimming structure 200. The active dimming structure can be formed within a lens as a stack or a set of layers of materials, each of which can be transparent to a wavelength range of between 400 nm and 800 nm. The set of layers of the active dimming structure 220 can include a first substrate 208 layer that is disposed or positioned to be nearest to, or exposed to, the antenna film layer 104. Adjacent to, or beneath the first substrate layer 208 (e.g., on the side of the first substrate layer 208 that is opposite of the side facing the antenna film layer 104) can be a first transparent conductive layer 110, beneath which a liquid crystal layer 212 can be formed or disposed, beneath which a second transparent conductive layer 110 can be formed or disposed, beneath which the bottom or second substrate 208 layer can be formed or disposed. The active dimming bias 114 component can be electrically coupled to the first transparent conductive layer 110 and the second transparent conductive layer 110 of the active dimming structure, to provide active dimming operation or functionality.

As the transparent conductive layer 110 faces or is exposed to the antenna radiation 204 of the antenna film layer 104, the antenna radiation 204 interacting with this transparent conductive layer 110 can cause or induce one or more lossy currents 206 on, or along this transparent conductive layer 110. The lossy currents 206 can dissipate radio frequency energy within the transparent conductive layer 110, reduce the efficiency of the antenna film layer 104 by diverting energy away from antenna radiation 204, interact with the active dimming circuit by introducing unintended current paths or altering the impedance characteristics of the transparent conductive layer 110, and affect the operation of the active dimming bias 114 or the modulation of the liquid crystal layer 212 by coupling radio frequency energy into the dimming circuit, which can sometimes result in signal interference, bias instability, or variation in the dimming response of the active dimming structure 220. To address these issues, the short structure 106 is applied between the transparent conductive layer 110 experiencing lossy current 206 and a ground node of the system, thereby dissipating the lossy current 206 from this layer.

The lens structure 200 can include at least one antenna film layer 104. The antenna film layer 104 can be disposed on at least a portion of the lens (e.g., 102) of the lens structure 200. The antenna film layer 104 can include any transparent material layer capable of emitting electromagnetic signals, such as a layer of transparent meshed metal, an indium tin oxide (ITO), a silver nanowire, graphene, a conductive polymer, a carbon nanotube network, a metallic grid, a nanowire mesh, an ultra-thin metal film, or any combination thereof. In some implementations, the antenna film layer 104 can include any optically transparent conductive material suitable for antenna operation and transparent to in the visible range (e.g., 400 nm to 800 nm wavelength range).

The antenna film layer 104 can function as a radiating element for an antenna and can facilitate wireless communication. The antenna film layer 104 can be implemented by depositing or laminating a transparent metal mesh or a conductive film onto the surface of the lens, over an active dimming stack. The antenna film layer 104 can cover the entire lens 102 as part of the antenna radiator. The antenna film layer 104 can be electrically coupled to a short structure 106, which may be implemented as a wire line providing a direct electrical connection or as a radio frequency (RF) short circuit that includes a high pass filter structure to manage current paths associated with radio frequency operation. A high pass filter may be configured to block signals below a designated cutoff frequency while allowing signals above that frequency to pass. A cutoff frequency can be, for example, any frequency between 50 Hz and 2.4 GHz, such as 100 kHz, 200 kHz or 500 KHz.

The antenna film layer 104 can radiate or emit at least one antenna radiation 204. The antenna radiation 204 can be any electromagnetic radiation (e.g., electromagnetic waves or wireless communication signals) emitted by the antenna component of the antenna film layer 104. The antenna film layer 104 can include one or more antennas or antenna components. In some configurations, the antenna film layer 104 can include a single antenna across the entirety of the antenna film layer 104. The antenna film layer 104 can include a transparent metal mesh, an ITO layer or other transparent conductive materials. The antenna radiation 204 can enable wireless communication by transmitting or receiving electromagnetic signals. The antenna radiation 204 can be generated by the flow of radio frequency currents in the antenna film layer 104. The antenna film layer 104 can be excited by an antenna feeding structure. For instance, the antenna film layer 104 can be fed capacitively through a flex along the frame 101 or directly at the opposite side of the nose pads. The antenna radiation 204 can propagate from the antenna film layer 104 in response to excitation by the antenna feeding structure.

The lens structure 200 can include at least one lossy current 206. The lossy current 206 can include one or more radio frequency currents induced in lossy conductive layers, (e.g., transparent conductive layer 110 formed using indium tin oxide), within the active dimming lens structure 200. The lossy current 206 can be induced in an ITO layer that is positioned closest to the antenna film layer 104 or that is exposed to the unobstructed path toward the antenna (e.g., 104). The lossy current 206 can cause signal loss and can reduce antenna efficiency by dissipating radio frequency energy as heat in the transparent conductive layer 110. The In some implementations, the lossy current 206 can be mitigated by electrically shorting the indium tin oxide layer to the antenna film layer 104 using a radio frequency short structure 106. The radio frequency short structure 106 can divert or cancel the lossy current 206. In some implementations, the active dimming lens structure 200 can include a radio frequency short structure 106 that is electrically coupled between the indium tin oxide layer and the antenna film layer 104 such that the lossy current 206 is conducted away from the indium tin oxide layer.

The lens structure 200 can include at least one active dimming structure 220. The active dimming structure 220 can include a multilayer stack that can be transparent to light in the 400 μm to 800 nm wavelength range. The multilayer stack can include a substrate 208 as a base layer, comprising for example a glass or a polyethylene terephthalate (PET) base layer, with a transparent conductive layer 110 (e.g., a layer of ITO) disposed above the base. A liquid crystal layer 212 (e.g., a gel layer) can be disposed between the transparent conductive layer 110 and another transparent conductive layer 110, that can be formed adjacent to another substrate 208 (e.g., another PET layer). The liquid crystal layer 212 (e.g., the gel layer) can include an electrochromic material or a liquid crystal material. The active dimming structure 220 can provide electrically controllable optical dimming for the lens. The active dimming structure 220 can be constructed by sequentially depositing or laminating the substrate 208, the first ITO layer, the gel layer, the second ITO layer, and the remaining substate 208 layer. In some configurations, one of the substrate layers may be removed, having one of the transparent conductive layers 110 as an ending layer of the stack. The active dimming structure 220 can be integrated with active dimming bias 114 structures or antenna structures. The active dimming structure 220 can be configured to adjust optical transmission in response to an applied electrical signal. While the thicknesses of the material layers may vary depending on the configuration, in some examples, the substrates 208 can be 20-1000 μm thick (e.g., 100 μm), the transparent conductive layers 110 can be 10-200 nm thick (e.g., 50 nm), while gel structure in between the layers 110 can be 20-50 μm thick (e.g., 30 μm).

The lens structure 200 can include at least one transparent conductive layer 110. The transparent conductive layer 110 can be any layer of transparent conductive material. For example, the transparent conductive layer 110 can include indium tin oxide, a silver nanowire network, a graphene film, a conductive polymer, a carbon nanotube network, a metallic grid, an ultra-thin metal film, or a nanowire mesh, among others. The transparent conductive layer 110 can include a mesh pattern that can be configured (e.g., shaped, formed or connected) to facilitate visible light transmission while maintaining electrical conductivity during operation (e.g., during active dimming). The transparent conductive layer 110 can be used for active dimming. The transparent conductive layer 110 can be fabricated as part of a multilayer stack. The multilayer stack can include a PET base layer, a first indium tin oxide layer disposed above the PET base layer, a gel layer that can include an electrochromic or liquid crystal material disposed above the first indium tin oxide layer, a second indium tin oxide layer disposed above the gel layer, and a PET top layer disposed above the second indium tin oxide layer. The transparent conductive layer 110 can be electrically coupled to a radio frequency short structure to mitigate radio frequency losses. The transparent conductive layer 110 can serve as an electrode for electrochromic or liquid crystal modulation. The transparent conductive layer 110 can interact with the antenna film layer and the radio frequency short structure to reduce lossy radio frequency currents.

The lens structure 200 can include at least one substrate 208. The substrate 208 can provide mechanical support for the active dimming lens structure 200. The substrate 208 can be implemented as a base material layer. Depending on implementations, the substrate 208 can include polyethylene terephthalate (PET) or polycarbonate, as well as glass, acrylic, or cyclic olefin copolymer, polymethyl methacrylate, polyetherimide, or any optically transparent polymer or composite material suitable for lens fabrication, among others. The substrate 208 can be fabricated with a thickness of about 100 micrometers, or any other thickness. The substrate 208 can be positioned as a base layer or as a top layer within the active dimming lens structure 200. The substrate 208 can support the deposition or lamination of conductive layers, functional layers, or antenna layers. The substrate 208 can maintain the structural integrity of the active dimming lens structure 200. For instance, the substrate 208 can be disposed below a first ITO layer or above a second ITO layer, in reference to proximity to the antenna radiating upon the first ITO layer. The substrate 208 can enable the formation of a multilayer stack for active dimming operation.

The lens structure 200 can include at least one liquid crystal layer 212. The liquid crystal layer 212 can include a gel layer of electrochromic material or liquid crystal material disposed, at least partially contained, enclosed or sealed between a first indium tin oxide (ITO) layer and a second ITO layer. The liquid crystal layer 212 can include any material layer that provides dimming responsive to an application or a change in voltage or current. The liquid crystal layer 212 can have a thickness of about 20 micrometers to about 50 micrometers. The liquid crystal layer 212 can modulate light transmission through the active dimming lens structure 200 in response to an applied electrical signal. The liquid crystal layer 212 can be sandwiched between the first ITO layer and the second ITO layer, where each ITO layer can serve as an electrode. When a voltage is applied across the first ITO layer and the second ITO layer, the liquid crystal layer 212 can change optical properties. The alignment of liquid crystal molecules in the liquid crystal layer 212 can alter the polarization of light passing through the active dimming lens structure 200, which can control the brightness or opacity of the lens. The liquid crystal layer 212 can be implemented as part of an electrochromic device operable to adjust optical transmission in response to an applied electrical signal.

The lens structure 200 can include at least one short structure 106. The short structure 106 can be a radio frequency (RF) short structure that can be electrically connected to the transparent antenna film layer 104 or to the transparent conductive layer 110. In some embodiments, the short structure 106 can be implemented as a short wire line that provides a direct electrical connection without any reactive components or additional circuitry. The short structure 106 can divert or cancel lossy radio frequency currents from the transparent conductive layer 110. The short structure 106 can prevent electrical interference between an antenna feeding structure and a dimming bias. Depending on the implementation, the short structure 106 can be implemented as part of a dimmer bias circuit or as a discrete component.

The short structure 106 can electrically couple the transparent conductive layer 110 to a ground of an AR glasses system. A ground can include any electrical node, conductive structure, or reference potential that can serve as a common return path for current within the AR glasses system, such as a metal chassis, a conductive trace, a dedicated ground plane, a common electrical node, or any other structure or component that can provide a reference potential for electrical circuits or components of the AR glasses system. In some implementations, a short structure 106 can be coupled between the ground and a first transparent conductive layer 110 (e.g., the 110 layer that is closest or nearest to the antenna film layer 104 out of all 110 layers in the stack), or between the ground and a second transparent conductive layer 110 (e.g., the 110 layer that is further or furthest away from the antenna film layer 104). In some implementations, a first short structure 106 can be coupled between an electrical ground and a first transparent conductive layer 110 and a second short structure 106 can be coupled between a second transparent conductive layer 110 and the electrical ground. The short structure 106 can electrically couple the transparent antenna film layer 104 to any electrical ground of the AR glasses system, such as a metal housing or a common node. The short structure 106 can couple either of these components to the ground either directly (e.g., via a wire line without any intervening electrical components disposed in the current path) or via one or more reactive components (e.g., forming a low pass, high pass, band pass filter, or band stop filter). The short structure 106 can be realized as part of the dimmer bias circuit such that additional bias lines are not utilized. The short structure 106 can be implemented as an RF short structure that is integrated into a circuit that conforms to one of a curvature of the lens of the eyewear device, or to a curvature of a bridge of the eyewear device (e.g., the bridge of an AR glasses system). The support structure for holding the lens comprising the lens structure can include a frame configured for eyewear, a visor, or a heads-up display device.

For instance, the short structure 106 can include an RF short circuit configuration that can include one or more of capacitors, resistors or inductors, in any combination. The RF short circuit can include a capacitor disposed in series along the short structure 106, such that the lossy current is dissipated via the capacitor. The RF short circuit can include a capacitor and a resistor circuit, an inductor and resistor circuit, or a capacitor, inductor and resistor circuit. The RF short circuit can be designed or configured to operate as an open circuit for lossy currents whose frequency is below a cut-off frequency of the short structure 106 and operate as a short circuit for lossy current whose frequency is above the cut-off frequency. The cut-off frequency can be, for example, 50 kHz, 100 KHz or 250 KHz.

Depending on the configuration and implementation, the short structure 106 can be configured as a radio frequency (RF) filtering structure, also referred to as a RF short structure, which can include, for example, a high pass filter, a low pass filter or a band pass filter. A high pass filter can be any circuit or arrangement that is configured to block or attenuate electrical currents or signals below a designated cutoff frequency and to pass signals above the designated cutoff frequency. For instance, the short structure 106 can be an RF short structure include a high pass filter (e.g., a capacitor disposed between the transparent conductive layer 110 and the ground) to blocks currents having periodic frequency of less than 100 Hz, 1 kHz, 5 kHz, 50 KHz, 100 kHz, or 500 kHz. In doing so, this RF short structure operating as the high pass filter can block or attenuate direct current or dimming bias signals operating at less than 100 Hz. The same RF short structure can allow higher-frequency signals (e.g., frequency signals above the cutoff frequency), such as radio frequency signals used for antenna operation (e.g., 2.4 GHz, 5 GHz or 6 GHZ) to pass without any significant attenuation through the RF short structure and to the ground.

Depending on the configuration and implementation, a low pass filter can be configured as an RF filtering structure, circuit or arrangement that is configured to pass currents or signals whose periodic frequency is below a designated cutoff frequency and to block signals above this designated cutoff frequency. The low pass filter (LPF) configuration for the RF short structure 106 can be used in scenarios in which it is desirable to allow low-frequency signals, such as dimming bias signals, to pass to ground while blocking higher-frequency radio frequency signals associated with antenna operation. In some implementations, the radio frequency (RF) short structure can be configured as a low pass filter by including a reactive component 214 that is an inductor connected between the antenna film layer 104 and ground. The inductor can present low impedance to low-frequency signals, such as dimming bias signals at frequencies up to 100 kHz, and high impedance to higher-frequency antenna signals, such as signals at 2.4 GHz or 5 GHz. In this configuration, the RF short structure can allow low-frequency signals to pass from the antenna film layer 104 to ground while blocking higher-frequency signals used for antenna operation. The RF short structure can thereby isolate the antenna film layer 104 from low-frequency signals that are not used for antenna purposes. The RF short structure can be placed between the antenna film layer 104 and ground to selectively pass or block signals based on frequency, depending on the desired filtering characteristics for the antenna system.

The short structure can include a band pass filter structure. A band pass filter can include an RF short structure, circuit or arrangement that is configured to pass signals within a designated frequency range and to block signals below and above this designated frequency range. The short structure 106 operating as a band pass filter can include a high pass filter and a low pass filter combined into a single structure. The short structure 106 can include a band pass filter that passes signals within a frequency range corresponding to antenna operation, such as between 2.4 GHz and 7 GHz, and blocks current signals outside that range (e.g., signals below 2 GHz and above 7 GHZ). For example, a high pass filter can be used to prevent low-frequency dimming bias from interfering with antenna signals, a low pass filter can be used to isolate dimming bias circuitry from radio frequency currents, and a band pass filter can be used to selectively pass antenna signals within a target operational frequency band while blocking both lower and higher frequency signals. In some implementations, the short structure 106 can include a band stop filter. A band stop filter can include a circuit or arrangement that is configured to block signals within a designated frequency range and to pass signals below and above this designated frequency range. The short structure 106 operating as a band stop filter can be used to attenuate or remove signals within a specific frequency band while allowing signals outside that band to be conducted.

The lens structure 200 can include at least one reactive component 214. The reactive component 214 can be any reactive component, such as a capacitor or an inductor. The reactive component 214 can be configured as part of a high-pass filter in an RF short structure 106. The RF short structure 106 can include a capacitor that can act as a high-pass filter with a cutoff frequency of about 100 kilohertz. The RF short structure 106 can include an inductor that can provide a similar filtering function (e.g., either deployed individually or in conjunction with another resistor or a capacitor). The reactive component 214 can block low-frequency signals, such as dimming bias signals from the active dimming bias 114, and can allow higher-frequency antenna signals (e.g., above the cutoff frequency) to pass via the reactive component 214 to the ground for the lossy current 206 to dissipate away from the transparent conductive layer 110. The configuration of the reactive component 214 can form a high-pass filter with a desired cutoff frequency, such that signals below the cutoff frequency can be blocked and signals above the cutoff frequency can be conducted. The RF short structure 106 can operate as a high-pass filter, such that direct current and signals up to about 100 kilohertz are blocked and signals above about 100 kilohertz are conducted.

The active dimming lens structure 200 can include at least one active dimming bias 114. The active dimming bias 114 can be an electrical bias that can be applied to the active dimming lens structure 200 to control optical transmission. The active dimming bias 114 can be provided through electrical connections to the indium tin oxide layers included in the active dimming lens structure 200. The active dimming bias 114 can operate at frequencies up to about 100 kilohertz. The active dimming bias 114 can enable modulation of a liquid crystal layer or an electrochromic layer included in the active dimming lens structure 200 to achieve variable dimming. In some implementations, the active dimming bias 114 can be applied such that the active dimming lens structure 200 is operable as an electrochromic device that can adjust optical transmission in response to an applied electrical signal. The active dimming bias 114 can be routed to the indium tin oxide layers at any location outside of an antenna feeding structure, an RF short structure, and a transparent antenna film layer. The RF short structure can be realized as part of a dimmer bias circuit, such that antenna signals are not affected by the active dimming bias 114. The configuration of the active dimming bias 114 can provide that the dimmer bias is located along an upper rim of the frame or at any location outside of the antenna feed flex, RF short structure, and transparent metal mesh area, regardless of the dimmer circuit configuration at radio frequency.

Referring now to FIG. 2B, illustrated is a cross-sectional schematic of a lens structure 250 with a pair of short structures utilized to dissipate lossy currents from the transparent conductive layer of the active dimming structure. While lens structure 250 is illustrated as a separate figure, it is understood that any feature, functionality or component of lens structure 200 of FIG. 2A can be included within, or combined with, the features or functions of lens structure 250 of FIG. 2B, and vice versa. As illustrated in FIG. 2B, the dimming structure 220 of the lens structure 250 can be same or similar to the one described in connection with the lens structure 200 of FIG. 2A. However, in the lens structure 250, a first short structure 106 can be coupled between the antenna film layer 104 and the ground in order to dissipate antenna radiation 204 that causes lossy currents 206 in the transparent conductive layer 110, thereby precluding or reducing the lossy currents 206 at the transparent conductive layer 110. The lens structure 250 can also include a second short structure 106 that is coupled between the transparent conductive layer 110 disposed to the antenna radiation 204 and the ground, which dissipates any lossy currents 206 via the reactive component 214 and to the ground. In some implementations, the design can include three or more short structure 106, a first short structure 106 being coupled between the antenna film layer 104 and the ground, a second short structure 106 being coupled between a first transparent conductive layer 110 (e.g., the layer 110 nearest to the layer 104) and the ground and a third short structure 106 being coupled between a second transparent conductive layer 110 (e.g., the layer 110 furthest from the layer 104) and the ground.

In FIG. 2B, the short structure 106 can be electrically coupled directly to the antenna film layer, rather than to the transparent conductive layer as in FIG. 2A. This short structure 106 can be a direct short (e.g., a wire line between the portion of the antenna film layer 104 and the ground) or an RF short structure (e.g., with one or more reactive components 214 used in the current path). In this configuration, the RF short structure 106 can be used to short circuit or shunt radio frequency currents from the antenna film layer 104 itself, thereby reducing the coupling of RF energy into the underlying lossy conductive layers. The RF short structure 106 can be a high pass filter, a low pass filter or a band pass filter, depending on the configuration. In some examples, the short structure 106 can be a direct wire line short structure (e.g., absent any reactive components, such as capacitors or inductors) to ground the antenna film layer 104 to the ground. By intercepting and shorting the RF currents at the antenna film layer 104 within a particular RF range, this configuration can mitigate the formation of lossy currents 206 within the transparent conductive layer 110 and can provide an alternative path for dissipating lossy or unwanted RF energy.

In the lens structure 250, the short structure 106 (e.g., configured to ground either the transparent conductive layer 110 or the antenna film layer 104) may be realized using a reactive component. The reactive component can be a capacitor or an inductor. The capacitor can be used to create a high pass filter between the target feature (e.g., the antenna film layer 104 or the transparent conductive layer 110) and the ground. In the configuration in which an inductor is used, the RF short structure can function as a frequency-selective element, such as a low-pass or band-pass filter, tailored to the operational frequency range of the antenna. The use of an inductor can provide similar frequency performance to the capacitor-based high-pass filter of FIG. 2A and can allow for flexibility when supporting consistent antenna performance across different lens stack configurations and product variants.

For example, the use of two short structures 106 can allow for flexibility in tuning the RF response of the system. The first short structure 106, connected to the antenna film layer 104, can be configured, tuned or adjusted to dissipate antenna-induced currents within a first frequency range (e.g., according to a first cutoff frequency) before the antenna-induced currents interact with the underlying transparent conductive layer 110 to cause lossy currents 206. For instance, the second short structure 106 can provide a separate path for any residual lossy currents 206 that present in the transparent conductive layer 110 to conduct those lossy currents 206 away from the active dimming structure 220 (e.g., and its transparent conductive layer). This separate path can be based on a different RF response with a different cutoff frequency. Such an arrangement can be advantageous in scenarios where coupling between the antenna and the transparent conductor or conductive layer (e.g., ITO layer) is not eliminated by a single short, or where additional sources of interference or parasitic effects are to be removed or attenuated. These additional interreferences or parasitic effects can be caused, for example, by stray capacitance between layers, manufacturing tolerances resulting in unintended conductive paths, or external electromagnetic interference that induces unwanted currents in the lens stack. The reactive component 214 (e.g., capacitor or inductor) used in each short structure may be independently selected for a particular frequency response (e.g., a particular cutoff frequency for a high pass filter or a low pass filter) and minimize RF losses on a particular operating band of the antenna.

FIG. 2C illustrates a lens configuration 260 in there is a single short structure 106 that is electrically connected between the antenna film layer 104 and the ground. The short structure 106 can be a direct short structure without any reactive components 214 (e.g., a wire line connection between the antenna film layer 104 and the ground). The short structure 106 can be an RF short structure in which one or more reactive components 214 are utilized to create a frequency filter (e.g., a high pass filter, a low pass filter or a band pass filter) that is electrically connected directly between the antenna film layer 104 and the ground. In some implementations of this configuration, the active dimming structure 220 may include no other short structure 106. This configuration can allow the RF short structure to shunt lossy currents 206 induced in the transparent conductive layer 110 by antenna operation, and may do so by providing a low-impedance RF path from the antenna film layer 104, rather than from the conductive layer 110. As a result, the shorting path can be established at the antenna level, which can offer flexibility in managing RF losses and can simplify the integration of the RF short structure with the antenna feed and grounding scheme.

The short structure 106 can be configured as an RF short structure that prevents electrical interference between an antenna feeding structure and an active dimming bias 114. For instance, in some implementations, the short structure 106 can include a capacitor that is electrically connected between the antenna film layer 104 and a ground, such that the short structure 106 forms a high pass filter with a cutoff frequency of about 100 kilohertz. In some implementations, the short structure 106 can include an inductor that is electrically connected between the antenna film layer 104 and the ground, such that the short structure 106 forms a low pass filter that passes signals up to about 7 gigahertz. The short structure 106 can be realized as part of a dimmer bias circuit, such that the short structure 106 provides a filtered electrical path for radio frequency currents while blocking low-frequency dimming bias signals.

The reactive component 214 of the RF short structure 106 of lens structure 260 in FIG. 2C can be positioned to act as a high-pass filter between the antenna film layer 104 and ground, thereby blocking frequency signals below a cutoff frequency (e.g., such as signals associated with the active dimming bias 114) while allowing frequency antenna signals above the cutoff frequency to be conducted to the ground. The reactive component 214 of the RF short structure 106 of lens structure 260 in FIG. 2C can be positioned to act as a low-pass filter between the antenna film layer 104 and ground, thereby blocking frequency signals above the cutoff current, while allowing frequency antenna signals with frequencies below the cutoff to be efficiently conducted. In some implementations, the reactive component 214 can provide a band pass filter having two cutoffs, a first cutoff frequency spaced apart in terms of frequency range from a second cutoff frequency to form a range of frequencies within which signals are passed and outside of which the signals are attenuated or removed. In some implementations, the reactive component 214 is a band stop filter, operating as inverse of band pass, where signals between the two cutoffs are blocked and signals outside of the two cutoffs (e.g., below the first cutoff and above the second cutoff frequency) are passed through. This arrangement can allow for isolating the antenna feed from the dimming bias circuitry, such as when the antenna film layer 104 is more accessible for direct electrical connection than the underlying transparent conductive layer. In some implementations, the short structure 106 can include or utilize any design, features or functionalities of the short structures 106 discussed in connection with lens structures 200 and 250 in FIGS. 2A and 2B, and vice versa.

FIG. 2D illustrates a cross-sectional schematic of a lens structure 270 configured for passive dimming. Passive dimming may include no transparent conductive layers such as indium tin oxide (ITO) layers. In the embodiment shown in FIG. 2D, the lens structure 270 can include a passive dimming structure 230 comprising at least one passive dimming layer 232, such as a photochromatic organic material, embedded between or within one or more optically transparent substrates 208. Unlike the active dimming stack, the lens structure 270 includes no transparent conductive layers or gel layers present, and the dimming effect can be achieved through the passive response of the organic molecules to ambient light conditions.

In the lens structure 270, the short structure 106 can be electrically connected to the antenna film layer 104. The short structure 106 can provide a radio frequency (RF) short for the antenna film layer 104. The passive dimming structure 230 can include a passive dimming layer 232 formed by embedding photochromatic organic molecules within the lens substrate 208. The passive dimming layer 232 can modulate optical transmission in response to ambient light conditions. The antenna film layer 104 can be disposed on at least a portion of the lens structure 270 and can serve as a radiating element for wireless communication. The short structure 106 can be configured to provide a direct or filtered electrical path between the antenna film layer 104 and ground, such that radio frequency currents induced in the antenna film layer 104 can be conducted away from the antenna film layer 104. The short structure 106 can maintain a consistent antenna-to-radio frequency front end architecture across product variants, including passive dimming and active dimming lens structures, providing improvements and efficiencies in the product manufacturing. The short structure 106 can thereby reduce the impact of stray currents or interference on antenna performance in the absence of lossy conductive layers.

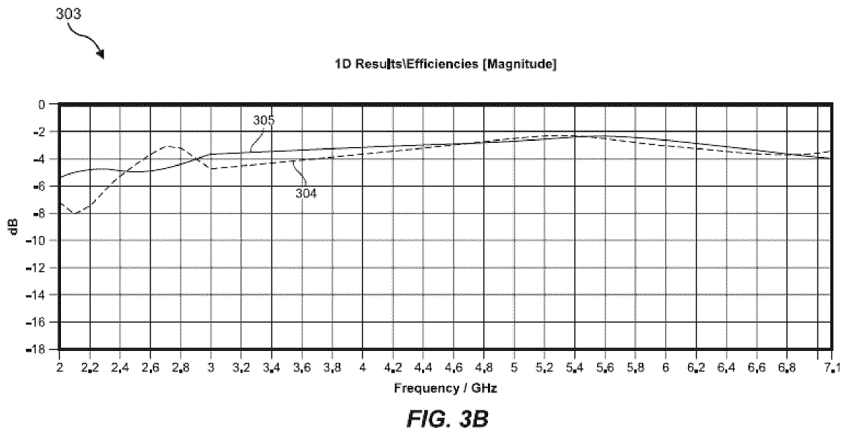

Referring to FIG. 3A, graph 300 may illustrate a simulation of the scattering parameters for AR glasses that use an RF short structure to support active dimming 301 and passive dimming 302. As defined herein, “scattering parameters”, or “s-parameters” may generally refer to an electrical behavior of linear electrical networks when undergoing various steady state stimuli by electrical signals. Referring to FIG. 3B, graph 303 may illustrate a simulation of the antenna efficiencies for AR glasses that use an RF short structure to support active dimming 305 and passive dimming 304. As defined herein, “antenna efficiency” may generally refer to a ratio of power delivered to the antenna relative to the power radiated from the antenna. As illustrated in FIGS. 3A and 3B, performance in scattering parameters for active dimming 301 and passive dimming 302 may be relatively similar and performance in antenna efficiencies for active dimming 305 and passive dimming 304 may be relatively similar.

FIG. 3A illustrates a scattering parameter graph 300 that depicts S-parameters [magnitude] for antenna systems operating under active dimming and passive dimming conditions. The scattering parameter graph 300 can include a frequency axis representing a range from approximately 2 GHz to 7.2 GHz and a magnitude axis in decibels (dB) ranging from 0 dB to −15 dB. The active dimming curve 301 can be illustrated as a dashed line, and the passive dimming curve 302 can be shown as a solid line. The active dimming curve 301 can correspond to antenna systems in which a transparent conductive layer 110 is present and electrically shorted to mitigate lossy radio frequency currents, as described in connection with the antenna-on-lens system for active dimming. The passive dimming curve 302 can correspond to antenna systems in which the lens structure does not include a lossy transparent conductive layer, such as in photochromatic dimming configurations. The scattering parameter graph 300 can show the magnitude of the S-parameters for both active dimming and passive dimming configurations across the frequency range of interest, including key wireless communication bands at approximately 2.4 GHz and 5 GHz. The active dimming curve 301 and the passive dimming curve 302 each exhibit minima at frequencies corresponding to antenna resonance, indicating effective antenna matching and reduced signal reflection at those frequencies. The similarity in the shape and magnitude of the active dimming curve 301 and the passive dimming curve 302 across the operational frequency bands indicates that the antenna-on-lens system with an RF short structure can maintain consistent antenna matching performance regardless of whether the lens structure employs active or passive dimming.

FIG. 3B can refer to an antenna efficiency graph 303 that depicts antenna efficiencies for active dimming and passive dimming configurations across a range of frequencies. The antenna efficiency graph 303 can include a passive dimming efficiency curve 304 and an active dimming efficiency curve 305, each plotted as a function of frequency in gigahertz (GHz) along the horizontal axis and efficiency in decibels (dB) along the vertical axis. The passive dimming efficiency curve 304 can represent the antenna efficiency for a lens structure configured with a passive dimming stack, such as a photochromatic lens without lossy conductive layers. The active dimming efficiency curve 305 can represent the simulated antenna efficiency for a lens structure configured with an active dimming stack, such as a guest-host liquid crystal or electrochromic lens including transparent conductive layers 110 in combination with a transparent antenna film layer 104 and a radio frequency (RF) short structure 106. The antenna efficiency graph 303 can show that both the passive dimming efficiency curve 304 and the active dimming efficiency curve 305 exhibit similar efficiency characteristics across the frequency range of approximately 2.0 GHz to 7.1 GHZ. The active dimming efficiency curve 305 can be slightly higher than the passive dimming efficiency curve 304 in certain frequency bands, indicating that the inclusion of the RF short structure can reduce efficiency losses associated with lossy conductive layers in the active dimming configuration. The antenna efficiency graph 303 provides that antenna efficiency is maintained across key wireless communication bands, including 2.4 GHz and 5 GHz, for both active and passive dimming lens structures.

The technical solutions can be implemented in conjunction with various types of artificial reality systems. Artificial reality can be a form of imaging or reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

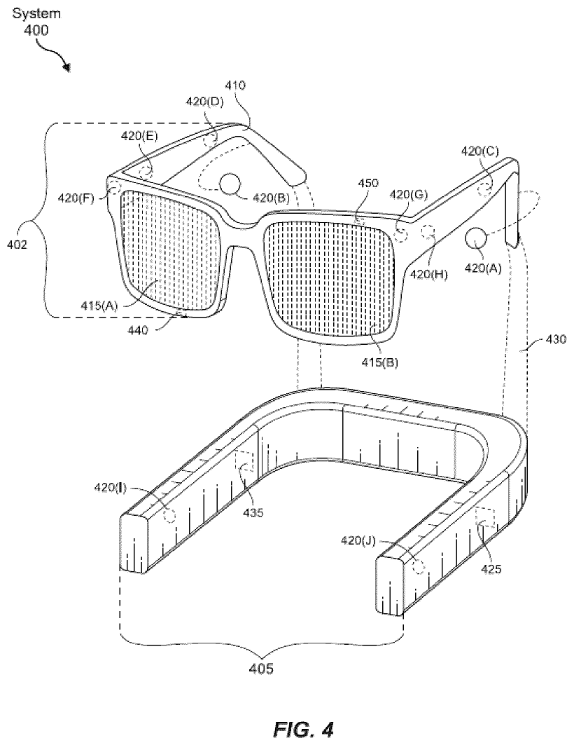

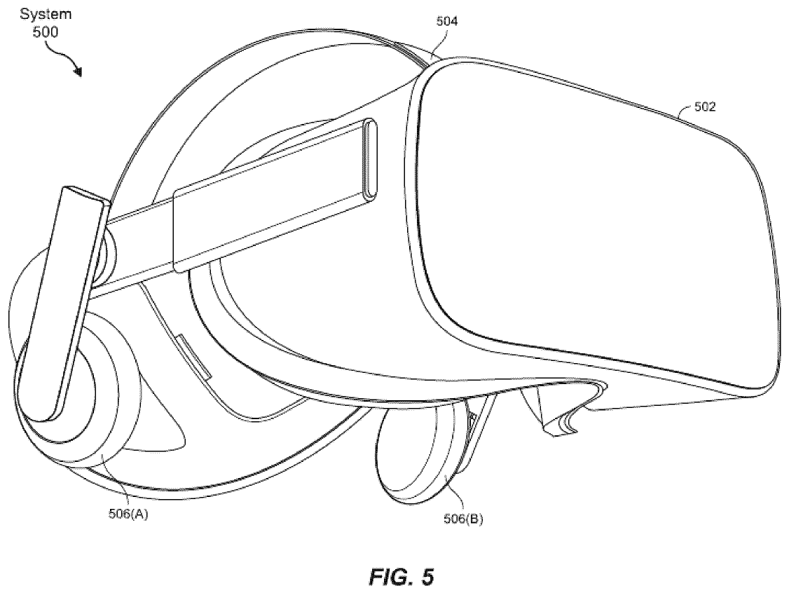

Artificial-reality systems may be implemented in a variety of different form factors and configurations. Some artificial-reality-systems may be designed to work without near-eye displays (NEDs). Other artificial-reality systems may include an NED that also provides visibility into the real world (such as, e.g., augmented-reality system 400 in FIG. 4) or that visually immerses a user in an artificial reality (such as, e.g., virtual-reality system 500 in FIG. 5). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 4, augmented-reality system 400 may include an eyewear device 402 with a frame 410 configured to hold a left display device 415(A) and a right display device 415(B) in front of a user's eyes. Display devices 415(A) and 415(B) may act together or independently to present an image or series of images to a user. While augmented-reality system 400 includes two displays, embodiments of this disclosure may be implemented in augmented-reality systems with a single NED or more than two NEDs.

In some embodiments, augmented-reality system 400 may include one or more sensors, such as sensor 440. Sensor 440 may generate measurement signals in response to motion of augmented-reality system 400 and may be located on substantially any portion of frame 410. Sensor 440 may represent one or more of a variety of different sensing mechanisms, such as a position sensor, an inertial measurement unit (IMU), a depth camera assembly, a structured light emitter and/or detector, or any combination thereof. In some embodiments, augmented-reality system 400 may or may not include sensor 440 or may include more than one sensor. In embodiments in which sensor 440 includes an IMU, the IMU may generate calibration data based on measurement signals from sensor 440. Examples of sensor 440 may include, without limitation, accelerometers, gyroscopes, magnetometers, other suitable types of sensors that detect motion, sensors used for error correction of the IMU, or some combination thereof.

In some examples, augmented-reality system 400 may also include a microphone array with a plurality of acoustic transducers 420(A)-420(J), referred to collectively as acoustic transducers 420. Acoustic transducers 420 may represent transducers that detect air pressure variations induced by sound waves. Each acoustic transducer 420 may be configured to detect sound and convert the detected sound into an electronic format (e.g., an analog or digital format). The microphone array in FIG. 4 may include, for example, ten acoustic transducers: 420(A) and 420(B), which may be designed to be placed inside a corresponding car of the user, acoustic transducers 420(C), 420(D), 420(E), 420(F), 420(G), and 420(H), which may be positioned at various locations on frame 410, and/or acoustic transducers 420(I) and 420(J), which may be positioned on a corresponding neckband 405.

In some embodiments, one or more of acoustic transducers 420(A)-(J) may be used as output transducers (e.g., speakers). For example, acoustic transducers 420(A) and/or 420(B) may be earbuds or any other suitable type of headphone or speaker.

The configuration of acoustic transducers 420 of the microphone array may vary. While augmented-reality system 400 is shown in FIG. 4 as having ten acoustic transducers 420, the number of acoustic transducers 420 may be greater or less than ten. In some embodiments, using higher numbers of acoustic transducers 420 may increase the amount of audio information collected and/or the sensitivity and accuracy of the audio information. In contrast, using a lower number of acoustic transducers 420 may decrease the computing power required by an associated controller 450 to process the collected audio information. In addition, the position of each acoustic transducer 420 of the microphone array may vary. For example, the position of an acoustic transducer 420 may include a defined position on the user, a defined coordinate on frame 410, an orientation associated with each acoustic transducer 420, or some combination thereof.

Acoustic transducers 420(A) and 420(B) may be positioned on different parts of the user's ear, such as behind the pinna, behind the tragus, and/or within the auricle or fossa. Or, there may be additional acoustic transducers 420 on or surrounding the car in addition to acoustic transducers 420 inside the car canal. Having an acoustic transducer 420 positioned next to an car canal of a user may enable the microphone array to collect information on how sounds arrive at the car canal. By positioning at least two of acoustic transducers 420 on either side of a user's head (e.g., as binaural microphones), augmented-reality device 400 may simulate binaural hearing and capture a 3D stereo sound field around about a user's head. In some embodiments, acoustic transducers 420(A) and 420(B) may be connected to augmented-reality system 400 via a wired connection 430, and in other embodiments acoustic transducers 420(A) and 420(B) may be connected to augmented-reality system 400 via a wireless connection (e.g., a BLUETOOTH connection). In still other embodiments, acoustic transducers 420(A) and 420(B) may not be used at all in conjunction with augmented-reality system 400.

Acoustic transducers 420 on frame 410 may be positioned in a variety of different ways, including along the length of the temples, across the bridge, above or below display devices 415(A) and 415(B), or some combination thereof. Acoustic transducers 420 may also be oriented such that the microphone array is able to detect sounds in a wide range of directions surrounding the user wearing the augmented-reality system 400. In some embodiments, an optimization process may be performed during manufacturing of augmented-reality system 400 to determine relative positioning of each acoustic transducer 420 in the microphone array.

In some examples, augmented-reality system 400 may include or be connected to an external device (e.g., a paired device), such as neckband 405. Neckband 405 generally represents any type or form of paired device. Thus, the following discussion of neckband 405 may also apply to various other paired devices, such as charging cases, smart watches, smart phones, wrist bands, other wearable devices, hand-held controllers, tablet computers, laptop computers, other external compute devices, etc.

As shown, neckband 405 may be coupled to eyewear device 402 via one or more connectors. The connectors may be wired or wireless and may include electrical and/or non-electrical (e.g., structural) components. In some cases, eyewear device 402 and neckband 405 may operate independently without any wired or wireless connection between them. While FIG. 4 illustrates the components of eyewear device 402 and neckband 405 in example locations on eyewear device 402 and neckband 405, the components may be located elsewhere and/or distributed differently on eyewear device 402 and/or neckband 405. In some embodiments, the components of eyewear device 402 and neckband 405 may be located on one or more additional peripheral devices paired with eyewear device 402, neckband 405, or some combination thereof.

Pairing external devices, such as neckband 405, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 400 may be provided by a paired device or shared between a paired device and an eyewear device, thus reducing the weight, heat profile, and form factor of the eyewear device overall while still retaining desired functionality. For example, neckband 405 may allow components that would otherwise be included on an eyewear device to be included in neckband 405 since users may tolerate a heavier weight load on their shoulders than they would tolerate on their heads. Neckband 405 may also have a larger surface area over which to diffuse and disperse heat to the ambient environment. Thus, neckband 405 may allow for greater battery and computation capacity than might otherwise have been possible on a stand-alone eyewear device. Since weight carried in neckband 405 may be less invasive to a user than weight carried in eyewear device 402, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 405 may be communicatively coupled with eyewear device 402 and/or to other devices. These other devices may provide certain functions (e.g., tracking, localizing, depth mapping, processing, storage, etc.) to augmented-reality system 400. In the embodiment of FIG. 4, neckband 405 may include two acoustic transducers (e.g., 420(I) and 420(J)) that are part of the microphone array (or potentially form their own microphone subarray). Neckband 405 may also include a controller 425 and a power source 435.

Acoustic transducers 420(I) and 420(J) of neckband 405 may be configured to detect sound and convert the detected sound into an electronic format (analog or digital). In the embodiment of FIG. 4, acoustic transducers 420(I) and 420(J) may be positioned on neckband 405, thereby increasing the distance between the neckband acoustic transducers 420(I) and 420(J) and other acoustic transducers 420 positioned on eyewear device 402. In some cases, increasing the distance between acoustic transducers 420 of the microphone array may improve the accuracy of beamforming performed via the microphone array. For example, if a sound is detected by acoustic transducers 420(C) and 420(D) and the distance between acoustic transducers 420(C) and 420(D) is greater than, e.g., the distance between acoustic transducers 420(D) and 420(E), the determined source location of the detected sound may be more accurate than if the sound had been detected by acoustic transducers 420(D) and 420(E).

Controller 425 of neckband 405 may process information generated by the sensors on neckband 405 and/or augmented-reality system 400. For example, controller 425 may process information from the microphone array that describes sounds detected by the microphone array. For each detected sound, controller 425 may perform a direction-of-arrival (DOA) estimation to estimate a direction from which the detected sound arrived at the microphone array. As the microphone array detects sounds, controller 425 may populate an audio data set with the information. In embodiments in which augmented-reality system 400 includes an inertial measurement unit, controller 425 may compute all inertial and spatial calculations from the IMU located on eyewear device 402. A connector may convey information between augmented-reality system 400 and neckband 405 and between augmented-reality system 400 and controller 425. The information may be in the form of optical data, electrical data, wireless data, or any other transmittable data form. Moving the processing of information generated by augmented-reality system 400 to neckband 405 may reduce weight and heat in eyewear device 402, making it more comfortable to the user.

Power source 435 in neckband 405 may provide power to eyewear device 402 and/or to neckband 405. Power source 435 may include, without limitation, lithium-ion batteries, lithium-polymer batteries, primary lithium batteries, alkaline batteries, or any other form of power storage. In some cases, power source 435 may be a wired power source. Including power source 435 on neckband 405 instead of on eyewear device 402 may help better distribute the weight and heat generated by power source 435.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 500 in FIG. 5, that mostly or completely covers a user's field of view. Virtual-reality system 500 may include a front rigid body 502 and a band 504 shaped to fit around a user's head. Virtual-reality system 500 may also include output audio transducers 506(A) and 506(B). Furthermore, while not shown in FIG. 5, front rigid body 502 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 400 and/or virtual-reality system 500 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 400 and/or virtual-reality system 500 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial reality systems described herein may also include various types of computer vision components and subsystems. For example, augmented-reality system 400 and/or virtual-reality system 500 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

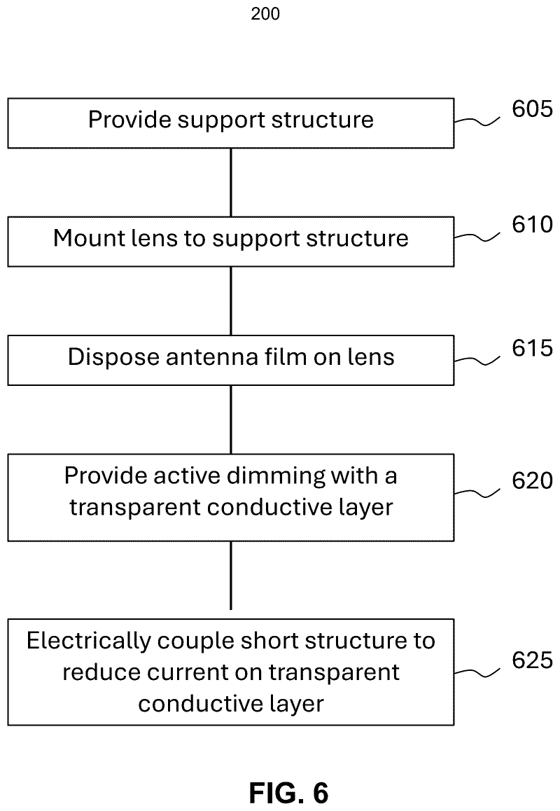

Turning now to FIG. 6, an example flow diagram of a method 600 for providing a lens structure configured to dissipate lossy currents from diming components of a lens structure. The method 600 can be performed as a part any system implementing active or passive dimming, such as a heads up display or AR glasses. The method 600 can include acts 605-625, which can be implemented in any order, out of order, with some acts being removed from certain implementations or one or more of the same acts being performed multiple times, as desired. At 605, the method can include providing a support structure. At 610, the method can include mounting lens to the support structure. At 615 the method can include disposing antenna film on a lens. At 620, the method can include providing active dimming with a transparent conductive layer. At 625, the method can include electrically coupling a short structure to reduce current on the transparent conductive layer.

At 605, the method can include providing a support structure. The support structure can serve as a mechanical element for holding, carrying, supporting or mounting one or more lenses. The support structure can include a frame, such as a frame that is configured for wearable optical devices such as augmented reality glasses, virtual reality headsets, or heads-up display devices. The support structure can be formed from materials such as plastic, metal, or composite materials, or any combination thereof. In some implementations, the support structure can be shaped to conform to the contours of a user's face or head. The support structure can include features for securing additional components, such as a transparent antenna film layer, a transparent conductive layer, or an antenna feeding structure. The support structure can further include electrical pathways or connectors to facilitate the integration of radio frequency short structures, dimming bias circuits, or other electronic elements required for antenna operation and dimming control.

At 610, the method can include mounting at least one lens to a support structure. The lens can be positioned within a designated recess or aperture formed in the support structure (e.g., a frame of the AR glasses or a heads up display device). The lens can be secured to the support structure using a mechanical retention feature such as a snap-fit, a groove, or a channel that receives an edge of the lens. In some implementations, an adhesive can be applied to a contact surface between the lens and the support structure to provide additional fixation. The lens can be aligned relative to the support structure such that optical axes of the lens and the support structure are collinear or otherwise oriented for intended optical performance. The mounting process can include electrically connecting conductive features disposed on the lens, such as antenna film layers or transparent conductive layers, to corresponding electrical contacts or pathways formed on the support structure. The mounting can be performed before or after other components, such as antenna film layers, are disposed on the lens.

The support structure can include features that accommodate electrical interconnections, such as flex circuits or conductive traces, that extend from the lens to other portions of the device. The mounting process can be performed using automated assembly equipment or manual techniques, depending on manufacturing requirements. The method can provide that the lens is secured in a manner that maintains mechanical stability and optical alignment throughout subsequent assembly steps and device operation.

At 615, the method can include disposing a transparent antenna film layer on at least a portion of a lens. The transparent antenna film layer can include at least one antenna or an antenna structure, which may be configured for wireless communication supporting a range of communication types, including but not limited to cellular, Wi-Fi, Bluetooth, global positioning system (GPS), ultrawideband (UWB), near-field communication (NFC), and other radio frequency protocols. The transparent antenna film layer can be formed using a transparent meshed metal, an indium tin oxide, a silver nanowire, a graphene, or any combination thereof. The transparent antenna film layer can be disposed over a transparent conductive layer of the lens. The transparent conductive layer of the lens can include an active dimming structure, which can include one or more indium tin oxide layers. The transparent antenna film layer can be electrically insulated from the transparent conductive layer by an intervening layer, such as a glass or polymer substrate. In some implementations, the transparent antenna film layer can be deposited, laminated, or otherwise formed on the surface of the lens to provide a radiating element for wireless communication.

The method can further include electrically coupling a radio frequency short structure to the transparent antenna film layer. The radio frequency short structure can include a reactive component, such as a capacitor or an inductor, which can be configured as a portion of a high pass filter or a band pass filter. In some implementations, the radio frequency short structure can be electrically connected to the transparent conductive layer of the lens. The radio frequency short structure can be configured to prevent electrical interference between an antenna feeding structure and a dimming bias. The antenna feeding structure can be configured to feed the transparent antenna film layer capacitively through a flex along the frame or directly at the opposite side of the nose pads. In some implementations, the radio frequency short structure can be realized as part of a dimmer bias circuit, such that no additional bias lines are required. The configuration can provide that the antenna-to-radio frequency front end architecture remains consistent for both active dimming and passive dimming lens structures.

At 620 the method can include providing an active dimming structure that includes a stack of layers formed on a lens. The stack of layers can form a lens structure that includes a base substrate that can be formed from glass, polycarbonate, polyethylene terephthalate, acrylic, cyclic olefin copolymer, polymethyl methacrylate, polyetherimide, or any other optically transparent polymer or composite material suitable for lens fabrication, among others. The lens structure can include a first transparent conductive layer that can be disposed next to or above the base layer. Disposed between the first transparent conductive layer and a second transparent conductive layer that is parallel to the first is a gel layer that includes an electrochromic material or a liquid crystal material. The gel layer can be partially enclosed, confined, supported between the first transparent conductive layer and the second transparent conductive layer that can be configured as parallel plates or components equally spaced apart between each other by the intervening gel. The top base substate or a layer can be formed from the same substrate material as the base substrate. The active dimming structure can be constructed by sequentially depositing or laminating the base layer, the first transparent conductive layer, the gel layer, the second transparent conductive layer, and the top layer, either directly, one on top of another, or with intervening layers.

The method can include positioning an active dimming structure a predetermined distance from an antenna film layer. The method can include setting or establishing the predetermined distance or space between the antenna film layer and the active dimming structure based on the thickness of an intervening electrically insulating layer (e.g., layer of base substrate) disposed between the antenna film layer and the active dimming structure. The method can establish or select the distance between the antenna film layer and the active dimming structure, for example, based on the thickness of one or more intervening layers, such as the substrate or a gel layer, included in the lens structure. The method can include configuring the spacing between the active dimming structure and the antenna film layer to reduce coupling or interference between the antenna film layer and the active dimming structure.

The method can include providing a passive dimming structure instead of the active dimming structure. The passive dimming structure can include a lens formed from a base substrate, such as glass, a polyethylene terephthalate substrate or a polycarbonate substrate. The passive dimming structure can include a passive dimming layer that includes photochromatic organic molecules embedded within the substrate of the lens. The method can include disposing a transparent antenna film layer on at least a portion of the lens. The transparent antenna film layer can include a transparent metal mesh or a transparent conductive film. The method can include electrically connecting a short structure (e.g., a radio frequency short structure) to the transparent antenna film layer. The radio frequency short structure can provide a radio frequency short for the transparent antenna film layer. The passive dimming structure can provide dimming functionality in response to ambient light conditions using the photochromatic organic molecules embedded in the lens material.

At 625, the method can include electrically coupling a short structure to reduce current on a transparent conductive layer of an active dimming structure. The method can include providing an active dimming structure that includes a transparent conductive layer, such as an indium tin oxide layer or a similar transparent conductive oxide, that is electrically coupled with a short structure. The short structure can be implemented as a radio frequency short structure that is configured to conduct current induced by an antenna away from the transparent conductive layer of the active dimming structure. The short structure can conduct the lossy current from the transparent conductive layer (e.g., indium tin oxide layer) of the active dimming structure to a ground node of the system.

The short structure can be realized as a high-pass filter that includes a reactive component, such as a capacitor, that blocks signals below a predetermined cutoff frequency and passes higher-frequency signals associated with antenna operation. The cutoff frequency can be set anywhere between the 50 Hz or 60 Hz of the active dimming bias operation and the frequency of the antenna communication (e.g., 2.4 GHz to 7 GHZ), such as at about 100 kilohertz. The cutoff frequency can configure the filter such that the short structure blocks low-frequency signals, such as dimming bias signals, and passes radio frequency signals in the gigahertz range. The method can include electrically coupling the short structure between the transparent conductive layer and a ground node of the system, such that lossy currents induced in the transparent conductive layer are diverted away from the active dimming structure.

The method can include electrically connecting the short structure to the transparent antenna film layer in addition to, or instead of, the transparent conductive layer. For instance, the method can include connecting the short structure (e.g., RF short structure or direct wire line short structure) between the transparent conductive layer and ground. For instance, the method can include connecting the short structure (e.g., RF short structure or direct wire line short structure) between the antenna film layer and the ground. For instance, the method can include connecting a first short structure (e.g., RF short structure or direct wire line short structure) between the transparent conductive layer and ground and a second short structure between the antenna film layer and the ground. For instance, the method can include connecting a third short structure (e.g., RF short structure or direct wire line short structure) between a second transparent conductive layer and the ground. Any combination of the three short structure can be utilized, depending on the configuration.

The method can include configuring the short structure to prevent electrical interference between an antenna feeding structure and a dimming bias, such that the antenna feeding structure can be fed capacitively through a flex along the frame or directly at the opposite side of the nose pads. The short structure can be realized using an inductor to form a low-pass filter, or as a band-pass filter to selectively pass signals within a desired frequency range. The method can include selecting the configuration of the short structure based on the desired frequency response of the antenna system and the characteristics of the active dimming structure. The short structure can be positioned to conform to a curvature of the lens or a curvature of a bridge of the eyewear device.

The method can include providing a lens structure for passive dimming that does not include a lossy conductive layer. The lens can be formed from a substrate material, such as glass, polyethylene terephthalate or polycarbonate, and can include a passive dimming layer formed by embedding photochromatic organic molecules within the lens material. The method can include disposing a transparent antenna film layer on at least a portion of the lens and electrically connecting a short structure to the transparent antenna film layer. The short structure can be configured to provide a radio frequency short for the antenna film layer, such that radio frequency currents induced in the antenna film layer are conducted away from the antenna film layer. The method can include maintaining a consistent antenna-to-radio frequency front end architecture across product variants, including both passive dimming and active dimming lens structures. The short structure can be realized as part of a dimmer bias circuit, or as a discrete component electrically coupled to the antenna film layer or the transparent conductive layer. The method can include selecting the materials, thicknesses, and electrical configurations of the short structure and the antenna film layer to achieve the desired antenna performance in both active and passive dimming configurations.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A system comprising:
a support structure;
at least one lens mounted to the support structure;
a transparent antenna film layer that is disposed on at least a portion of the lens, wherein the transparent antenna film layer includes at least one antenna; and
an active dimming structure comprising a transparent conductive layer that is electrically coupled with a radio frequency (RF) short structure configured to conduct current induced by the antenna away from the transparent conductive layer of the active dimming structure.

2. The system of claim 1, wherein the RF short structure comprises a reactive component configured as a portion of a high pass filter, the reactive component comprising at least one of a capacitor or an inductor.

3. The system of claim 2, wherein the high pass filter comprises a cut-off frequency of at least 100 kilohertz.

4. The system of claim 1, further comprising a second RF short structure that is electrically coupled with the antenna, wherein the second RF short structure comprises a second reactive component comprising at least one of a capacitor or an inductor, the second reactive component configured to reduce coupling between the antenna and the transparent conductive layer.

5. The system of claim 4, wherein the second reactive component is configured as a portion of a band pass filter, the band pass filter allowing for passing of signals with a frequency range of at least between 2.4 GHz and 7 GHz.

6. The system of claim 4, wherein each of the RF short structure and the second RF short structure is coupled to a common ground coupled with at least a portion of the support structure.

7. The system of claim 1, wherein the transparent antenna film layer comprises at least one of: an indium tin oxide (ITO), a silver nanowire, or a graphene.

8. The system of claim 1, wherein the active dimming structure is configured as an electrochromic device operable to adjust optical transmission in response to an applied electrical signal.

9. The system of claim 1, wherein the RF short structure is integrated into a circuit that conforms to one of a curvature of the lens of an eyewear device, or a curvature of a bridge of the eyewear device.

10. The system of claim 1, wherein the support structure comprises a frame configured for eyewear, a visor, or a heads-up display device.

11. The system of claim 1, wherein the transparent conductive layer comprises a mesh pattern configured to facilitate visible light transmission while maintaining electrical conductivity.

12. A system comprising:
a support structure;
at least one lens mounted to the support structure;
a transparent antenna film layer that is disposed on at least a portion of the lens, wherein the transparent antenna film layer includes at least one antenna; and
a radio frequency (RF) short structure that is electrically connected to the transparent antenna film layer.

13. The system of claim 12, wherein the transparent antenna film layer comprises a transparent meshed metal.

14. The system of claim 13, wherein the transparent antenna film layer is disposed over a transparent conductive layer of the lens.

15. The system of claim 14, wherein the transparent conductive layer of the lens comprises an active dimming structure including one or more indium tin oxide (ITO) layers.

16. The system of claim 15, wherein the RF short structure is electrically connected to the transparent conductive layer.

17. The system of claim 12, wherein the RF short structure is configured to prevent electrical interference between an antenna feeding structure and a dimming bias.

18. A method for providing a lens structure with active dimming, the method comprising:
providing a support structure;
mounting at least one lens to the support structure;
disposing a transparent antenna film layer on at least a portion of the lens, the transparent antenna film layer including at least one antenna;
providing an active dimming structure comprising a transparent conductive layer;
electrically coupling the transparent conductive layer with a radio frequency (RF) short structure to conduct current induced by the antenna away from the transparent conductive layer via the RF short structure.

19. The method of claim 18, wherein the RF short structure comprises a reactive component configured as a portion of a high pass filter, the reactive component comprising at least one of a capacitor or an inductor.

20. The method of claim 19, wherein the high pass filter comprises a cut-off frequency of at least 100 kilohertz.
